(19) United States
(12) Patent Application Publication
(10) Pub. No.: US 2004/0064313 A1
(43) Pub. Date: Apr. 1, 2004

(54) Noise reduction apparatus with a function of preventing data degradation

(76) Inventor: Yoshinori Shimosakoda, Tokyo (JP)

Correspondence Address: RABIN & Berdo, PC, 1101 14TH STREET, NW, SUITE 500, WASHINGTON, DC, 20005, US

(21) Appl. No.: 10/424,872

(22) Filed: Apr. 29, 2003

(30) Foreign Application Priority Data
Oct. 1, 2002 (JP) 2002-288182

(51) Int. Cl. G10L 21/02

(52) U.S. Cl. 704/226

(57) ABSTRACT

A noise reduction circuit suppressing noise ascribable to a bit error to prevent the data quality from being lowered includes a data storage storing input data chronologically continuously supplied. The data storage includes three data registers connected in tandem to each other. The noise detector detects the magnitude of the noise, using three pieces of data respectively supplied from the three data registers to feed an output selector with an output selection signal, selecting noise correction or non-correction, depending on the comparison of the magnitude of the detected noise with a preset threshold. The output selector outputs either one of the inherent input data to be output and correction data calculated by a correction value calculator, depending on the output selection signal, to perform correction on the noise larger than the threshold value.

### BACKGROUND OF THE INVENTION

1. Field of the Invention

The present invention relates to a noise reduction apparatus, and more particularly a noise reduction apparatus applicable to a speech data processing circuit based on, for example, the Bluetooth standard.

2. Description of the Background Art

It is currently contemplated to provide a personal computer or a household electrical utensil with an added-value function. As typical of the products, provided with such an added-value function, a radio communications device, operating under a digital wireless standard, such as the Bluetooth, has recently been under development.

In general,the radio communications between such radio devices may include bit errors in carried information. With radio communications devices, in order to correct involved bit errors to establish correct radio communications, a variety of error correction systems have so far been proposed. In meeting with these proposals, practical devices have actually been developed also. In certain proposed systems, designed to correct the errors completely, the codes used are necessarily lengthy. Since the use of such lengthy codes requires higher speed processing invoice communications, the use of such lengthy codes is a trade-off for the attempt to develop the encoding at a lower bit rate, and hence these systems are not accepted widely.

In an incomplete error correction system in which emphasis is placed on coding with the lower bit rate, as contrasted to the system with lengthy codes, speech data are unavoidably containing bit errors. If speech data containing bit errors are reproduced, the bit errors are actualized as noise in reproduced speech signals, thus degrading the sound quality. In particular, with the code conversions, in the PCM (Pulse Code Modulation) encoding, by means of the PCM linear, based on the compressing/expanding (companding) law of linear characteristics, and by means of the PCM A-law and the PCM μ-law, based on the compressing/expanding law of non-linear characteristics for effectively improving the SN ratio, there may be occasions where one-bit error causes a stronger noise.

When the latter error correction system is applied, noise removal from speech data is implemented by a low-pass filter (LPF) or a band-pass filter (BPF), depending on the bandwidth of the noise involved.

However, the measures taken to remove noise in the incomplete error correction system increase the scale of the filter circuit used for noise removal, and render it difficult to reduce the size and weight of the hardware loaded with the error correction system. Moreover, the filter circuit, thus loaded, possibly affects even onto normal signals so as to lead to degradation in the overall sound quality.

### SUMMARY OF THE INVENTION

It is an object of the present invention to provide a noise reduction apparatus to suppress noise ascribable to bit error to prevent the data from being degraded in quality.

The present invention provides a noise reduction apparatus comprising a data storage having a plurality of stages for holding input data with the chronological relationship of the input data maintained, an output controller for detecting the magnitude of the noise using data held by and output from the data storage and for comparing the magnitude of the detected noise to a threshold value to produce a selection signal selecting data to be output, a correction value calculator for using the held data to calculate correction data for the data to be output, and an output selector operative in response to the selection signal for selecting either one of the data to be output and the correction data from among the held data.

With the noise reduction apparatus of the present invention, the input data, supplied chronologically continuously, is stored in the stages of the data storage. The output controller uses the data held in the stages to detect the magnitude of the noise, and supplies the output selector with the selection signal for selecting the possible necessity for noise correction based on the result of comparison. In response to the selection signal-, the output selector develops either one of the inherent output signal and correction data calculated by the correction value calculator. The input data is corrected for the noise detected on the bit-by-bit basis to suppress the noise with the size of the circuitry diminished appreciably as compared to the circuitry comprised of a filter circuit. This also keeps the sound quality at a high level at the time of reproduction.

With the noise reduction apparatus of the present invention, in which input data is corrected for the noise determined abnormal on the bit-by-bit basis to suppress the noise, it is possible to prevent the input signal from being deteriorated in signal quality, in particular in reproducing the speech data. Moreover, the configuration of the present invention enables the size of the circuitry to be reduced significantly as compared to the size of the circuitry including the filter circuit, thus contributing to reduction in size of the equipment on which the apparatus is installed.

### BRIEF DESCRIPTION OF THE DRAWINGS

The objects and features of the present invention will become more apparent from consideration of the following detailed description taken in conjunction with the accompanying drawings in which:

FIG. 1 is a schematic block diagram showing the configuration of an embodiment of a noise reduction circuit employing a noise reduction apparatus of the present invention;

FIG. 2 is a schematic block diagram showing a specific configuration of a noise detector in the noise reduction circuit of FIG. 1;

FIG. 3 is a schematic block diagram showing a specific configuration of a correction value calculator in the noise reduction circuit of FIG. 1;

FIG. 4 plots a waveform useful for understanding the principle of noise reduction carried out in the noise reduction circuit of FIG. 1;

FIGS. 5 and 6 are schematic block diagrams respectively showing the configuration of a first and a second modification of the noise reduction circuit of FIG. 1;

FIG. 7 is a schematic block diagram showing the configuration of a threshold value calculator in FIG. 6;

FIG. 8 is a schematic block diagram showing the configuration of a third modification of the noise reduction circuit of FIG. 1; and

FIG. 9 is a schematic block diagram showing the configuration of a threshold value calculator in FIG. 6.

### DESCRIPTION OF THE PREFERRED EMBODIMENTS

Referring to the drawings, certain preferred embodiments of the noise reduction apparatus of the present invention will be described in detail. The illustrated embodiments include a noise reduction circuit 10 in accordance with the invention. It is to be noted that parts of the noise reduction circuit not relevant to understanding the invention are not specifically shown nor described. Signals appearing in the illustrative embodiment are designated wiht reference numerals attached to connections on which they appear.

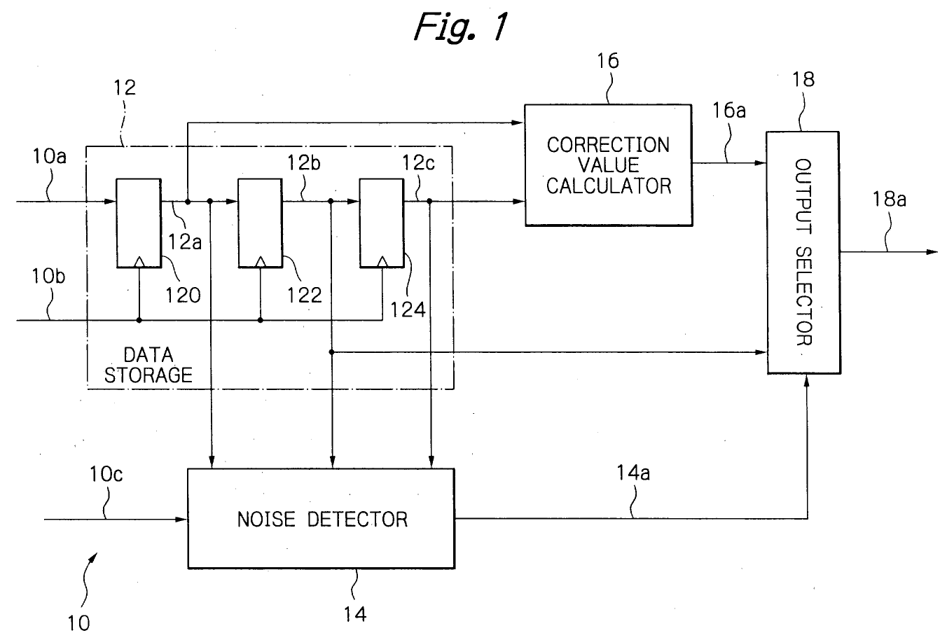

Referring to FIG. 1, the noise reduction circuit 10 includes a data storage 12, a noise detector 14, a correction value calculator 16 and an output selector 18 interconnected as illustrated. In the data storage 12, there are provided at least three data registers 120, 122 and 124, which are in the form of D type flip-flops. In the present embodiment, the data register 120 is connected to receive input data 10a.

The input data 10a in the present embodiment include speech data received by a receiver in radio communications conforming to the Bluetooth standard. Of course, the input data 10a are not limited to the speech.

Each of the data registers 120, 122 and 124 has its input connected in tandem to the next data register following thereto. More specifically, the data register 120 is adapted to receive the input data 10a to output an output signal 12a to the data register 122. The data register 122 in turn receives the output signal 12a as an input signal to output an output signal 12b to the data register 124. The data register 124 outputs an output signal 12c to a correction value calculator 16. Moreover, the data registers 120, 122 and 124 are adapted to respectively send out the output signals 12a , 12b and 12c to the noise detector 14. The data registers 120 and 124 are adapted to respectively send out the output signals 12a and 12c to the correction value calculator 16. The data registers 120, 122 and 124 are supplied with common clock signals 10b. In the present embodiment, the clock signals used are of 8 kHz.

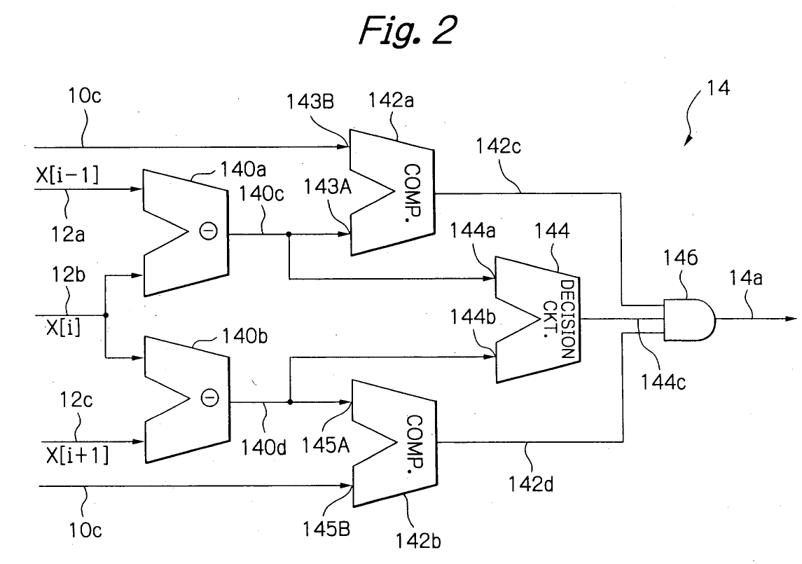

The noise detector 14 is adapted for using the output signals 12a , 12b and 12c supplied from the data storage 12 to check if the output signal 12b is larger than the threshold value 10c so as to produce an output selection signal 14a. In the present embodiment, the threshold value 10c is a predetermined, fixed value. In the noise detector 14, as shown in FIG. 2, there are provided subtracters 140a and 140b, comparators 142a and 142b, a decision circuit 144 and a comprehensive noise decision circuit 146. The subtracter 140a is adapted to calculate a difference (x[i+1]−x[i]) between the output signals 12a and 12b . The subtracter 140a outputs results of calculations 140c to one terminal 143A of the comparator 142a and to one terminal 144a of a decision circuit 144. The subtracter 140b calculates a difference (x[i1]−x[i−1]) between the output signals 12b and 12c . The subtracter 140b outputs results of calculations 140d to one terminal 145A of the comparator 142b and to one terminal 144b of a decision circuit 144.

The comparator 142a has the function of determining the absolute value of the difference, or results of calculations, 140c on its one terminal 143A and comparing the absolute value to the threshold value 10c (TH) supplied on its other terminal 143B. If the difference of the absolute value of the difference from the threshold value is positive, the comparator 142a then outputs the level “H” as the results of calculations 142c. If otherwise, the comparator 142a outputs the level “L” to the comprehensive noise decision circuit 146. The other comparator 142b , on the other hand, has the function of determining the absolute value of the difference, or results of calculations, 140d on its one terminal 145A and comparing the absolute value to the threshold value 10c (TH) supplied on its other terminal 145B. If the difference of the absolute value of the difference from the threshold value is positive, the comparator 142b outputs the level “H” as the results of calculations 142d. Otherwise, the comparator 142b outputs the level “L” to the comprehensive noise decision circuit 146.

The decision circuit 144 has the function of determining whether or not the differences supplied from the terminals 144a and 144b are of opposite sign to each other, or whether or not the results from multiplication of the differences are of negative sign. If the decision circuit 144 has verified that the differences are of opposite sign to each other, or the results from multiplication of the differences are of negative sign, the decision circuit 144 outputs the level “H” as the results of decision 144c to the comprehensive noise decision circuit 146. If otherwise, the decision circuit 144 outputs the level “L” on its output port 144c.

The comprehensive noise decision circuit 146 is implemented by a three-input one-output logical sum (AND) gate circuit. The comprehensive noise decision circuit 146 is supplied with the results of comparison 142c and 142d, representing the conditions for noise detection, as its input signals, and with the results of decision 144c. When the conditions are met for a detection of noise, more specifically, when all of the input signals take the level “H” thereof, the comprehensive noise decision circuit 146 determines that the noise has been detected to output the level “H” as the output selection signal 14a to the output selector 18 so as to cause the selector 18 to select the correction value. Otherwise, the comprehensive noise decision circuit 146 comprehensively determines that no error has been detected to output the level “L” as the selection signal 14a to the output selector 18 so as to allow the selector 18 to select the signal 12b.

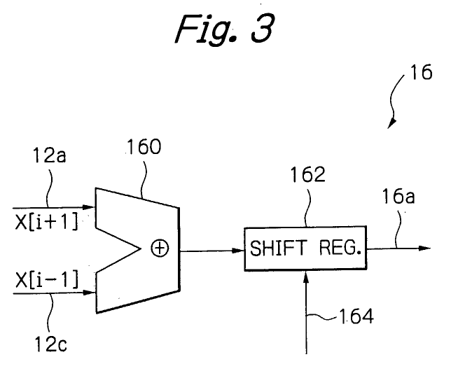

Returning to FIG. 1, the correction value calculator 16 has the function of calculating a correction value for data upon having detected noise. In the present embodiment, the correction value calculator 16 calculates data X[i], as an average value, using data X[i+1] and X[i−1] sampled immediately before and after data detected to be noisy. Referring to FIG. 3, the correction value calculator 16 includes an adder 160 and a shift register 162 interconnected as shown. The adder 160 is adapted to sum the data X[i+1] and X[i−1] to output the resulting sum to the shift register 162. The shift register 162 is adapted to shift the sum data one bit to the following stages in timed with a timing signal 164 supplied. By this shifting, the shift register 162 outputs the result corresponding to the input data multiplied by 0.5. The correction value calculator 16 thus ultimately produces the average value. The correction value calculator 16 outputs the average value to the output selector 18 as a correction value 16a.

Reverting again to FIG. 1, the output selector 18 includes a selector switch, not shown, adapted for selecting either one of the output signal 12b (X[i]), as sampled data, and the correction value 16a, dependent upon the output selection signal 14a issued in response to the noise detection. The output selector 18 outputs, as the output signal 18a, either one of the noise-reduced correction signal and a signal inherently lower in noise. By this selective switching, correction is applied only to a bit corrupted with a bit error, while the remaining, normal bits may be output without being suppressed by essentially unneeded signal processing.

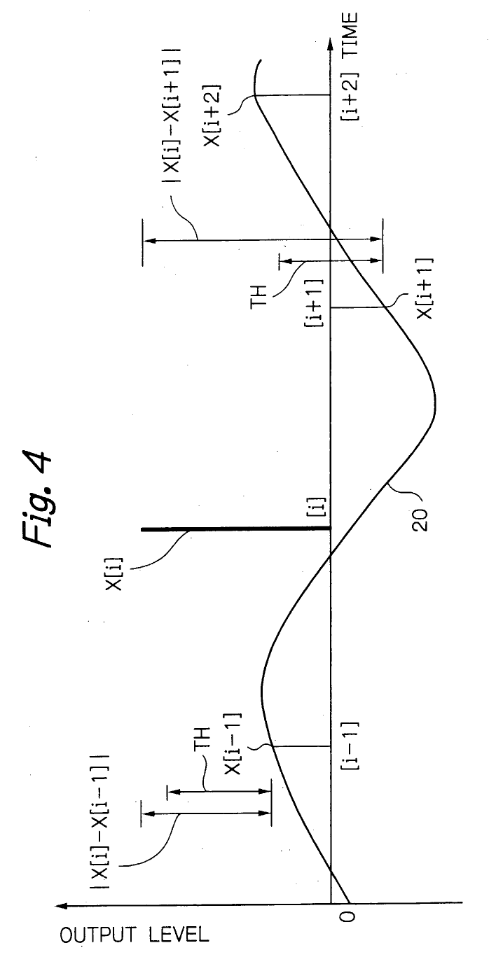

Referring to FIG. 4, the operating principle of the noise detector 14 is briefly described. In FIG. 4, the abscissa is the time axis on which the discrete sampling points are indicated which are defined by the clock signals 10b, while the ordinate shows the output level of the noise detector 14. The noise detector 14 detects the noise as it pays attention to the output signals 12a X[i+1] and 12c X[i−1] immediately before and after the output signal 12b X[i], respectively. A curve 20 in the figure indicates speech data actually changing with time. The sampled value X[i] at the time point [i] in FIG. 4 corresponds to a case in which the output signal 12b , which should otherwise be on the curve 20, is extremely larger towards the positive side. In this case, when the magnitudes of the data take such relationships that X[i]>X[i+1] (i.e. X[i]−X[i+1]>0) and X[i]>X[i−1] (i.e. X[i−1]−X[i]<0) and the absolute values of the difference |X[i]−X[i+1]| and |X[i]−X[i−1] are both larger than the threshold TH, it is then determined that a large noise is on the data X[i].

The noise may be caused such that the sampled value X[i] at a time point [i] on the curve 20 is extremely large in the negative direction. In this case, when the magnitudes of the data take such relationships that X[i+1]>X[i] (i.e. X[i]−X[i+1]<0) and X[i−1]>X[i] (i.e. X[i−1]−X[i]>0), and the absolute values of the difference |X[i+1]−X[i] and |X[i−1]−X[i]| are both larger than the threshold TH, it is the determined that a large noise is on the data X[i]. More specifically, the noise detection condition for the data X[i] is that the differences differ in sign with the absolute values of the differences from the immediately previous and posterior sampled values are larger than the threshold value TH. The noise detection is thus accomplished if the condition defined in either of the present and previous paragraphs holds. Thus, the conditions may be expressed in Boolean logics: (X[i]>X[i−1] && |X[i]−X[i−1]|>TH && X[i]>X[i+1] && |X[i]−X[i+1]|<TH) ||(X[i−1]>X[i] && |X[i−1]−X[i]|>TH && X[i+1]>X[i] && |x[i+1]−X[i]|>TH).

The noise detector 14 constructs the circuit to reflect this condition and sends the output selection signal 14a to the output selector 18 so that the correction value 16a will be selected responsive to detection. On the other hand, the correction value calculator 16 generates an average value of the data X[i+1] and X[i−1] as a new correction value in the data X[i]. The noise reduction circuit 10 is responsive to noise detection to output a correction value 16a from the output selector 18. Otherwise, the noise reduction circuit 10 outputs a normal signal free of bit errors.

In this manner, only the bits suffering from the bit error may be selectively suppressed without affecting the normal signals, thus preventing the data quality, for example, the sound quality, from being lowered.

Meanwhile, several concepts of correctly transmitting the information taking the time into account have so far been proposed. For example, Japanese Patent Laid-Open Publication No. 177641/1999 proposes a method of allocating control information in which a set of the current and past pieces of control information is allocated to a sole transmission symbol, to which a preset constraint condition is added to impart the ability for error correction to the transmission symbol to transmit the control information with high accuracy.

Japanese Patent Laid-Open Publication No. 298335/1999 discloses an error correction circuit for the (n, k) code received over a radio communication channel. The error correction circuit includes means for determining such a portion of the received signal associated with k information bits which is lowered in level, means for specifying the position of the determined portion, means for correcting the specified position taking account of a delay in processing and the processed content of the signal processing section of the receiver system, and means for inverting specific one of the k information bits which resides in the correction position to correcting the error. Since the bit of such a targeted portion is inverted, the processing time for error correction can be shorter than if the totality of bits is targeted.

There has also been proposed a receiver device in which the noise in the signal is measured to estimate the code error rate in Japanese Patent Laid-Open Publication No. 2002-111771. This receiver device is of a transmission system for digital modulated signals in which the distance of a signal dot given by a received signal from the central point set for demodulation is calculated as a noise level, which is then divided by the distance between the signal dots determined from the modulation system, to calculate the ratio of the noise to the distance between the signal dots, thus enabling the code error rate to be recognized.

The method taught in the aforementioned Publication No. 177641/1999 may be similar to the system of the present invention only in taking time changes of the information into account. The disclosed controlling method consists in adding predetermined constraint conditions to the transmission symbol peculiar to the Viterbi coding to thereby impart the error correction capability. However, the noise reduction circuit 10 of the embodiment of the present invention attempts to reduce the noise, responsive to the detection of the noise level, without regard to the Viterbi coding.

The system taught in the aforementioned Publication No. 298335/1999 may be similar to the system of the present invention only in detecting the lowering in the signal level, specifying and correcting its position, and making error correction to execute partial error correction. The level detection taught in the latter publication is performed such that the signal level is compared to a certain threshold value, and the portion lower than the threshold value is determined as a lowered level portion, which means that the level detection is of a direct level comparison. The threshold value is variable depending on an average value on the time domain of the signal level. The noise reduction circuit 10 of the embodiment of the present invention uses the values at the sampling points temporarily before and after target data on the time domain to verify whether or not noise is included under the noise conditions, as definitely differs from the publication.

Moreover, the noise reduction circuit 10 of the embodiment of the invention is simply adapted to select the correction value 16a depending on whether or not the aforementioned noise conditions are met, without calculating the ratio of the distance between signal dots to the noise done in above-stated publication No. 2002-111771. The noise reduction circuit 10 of the illustrative embodiment is not obvious over a combination of the three prior art publications.

With the illustrative embodiment of the invention, if noise is caused by bit error, only the relevant signal (bit) is subject to noise correction in response to noise detection. That not only causes the noise to simply be suppressed, but allows the overall signal quality to be maintained higher than the signal processing applying the noise suppression to the entire signal, thus preventing the signal quality from being lowered.

A modification of the noise reduction circuit 10 will now be described. In the following description, the portions like those of the previous embodiment are designated with the same reference numerals and the detailed description will be omitted for avoiding the redundancy.

<First Modification>

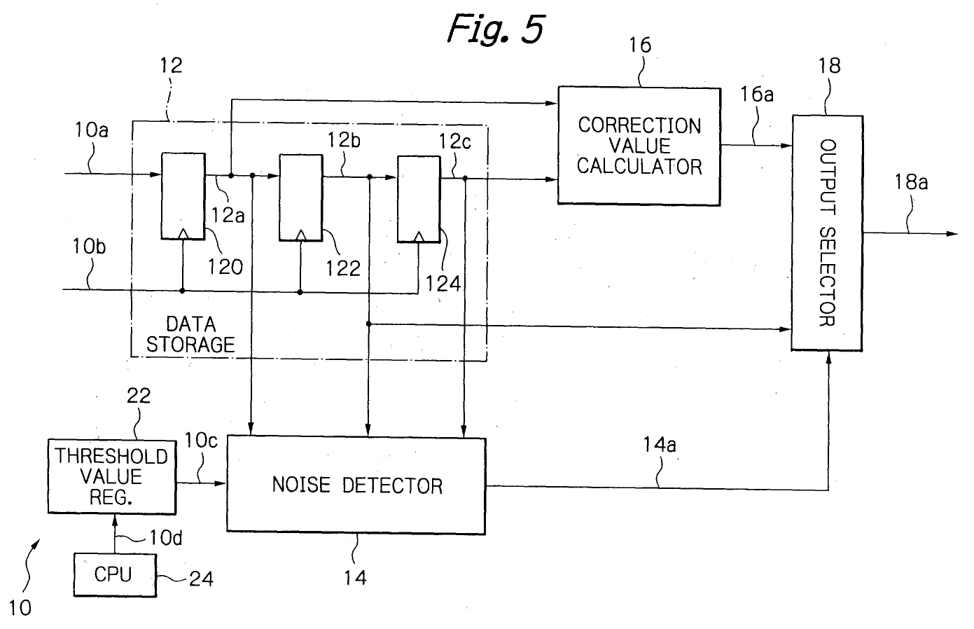

Referring to FIG. 5, the noise reduction circuit 10 includes a threshold value register 22 and a CPU (central processing unit) 24 interconnected as illustrated, in addition to the components included in the circuit configuration of the previous embodiment. The threshold value register 22 is adapted for storing data. The threshold value register 22 holds a threshold value 10d, supplied from the CPU 24, and supplies the threshold value 10c, read out at a preset timing, to the noise detector 14. The CPU 24 has the function of generating the threshold value 10d to supply it to the threshold value register 22.

With this configuration, in contradistinction to the previously described arrangement, the setting of the threshold value is dynamically changeable. This allows the noise to be suppressed to maintain the high sound quality as well as to the degree of freedom to increase in noise detection as compared to the arrangement of the previous embodiment, thus increasing the processing flexibility in the noise detection.

<Second Modification>

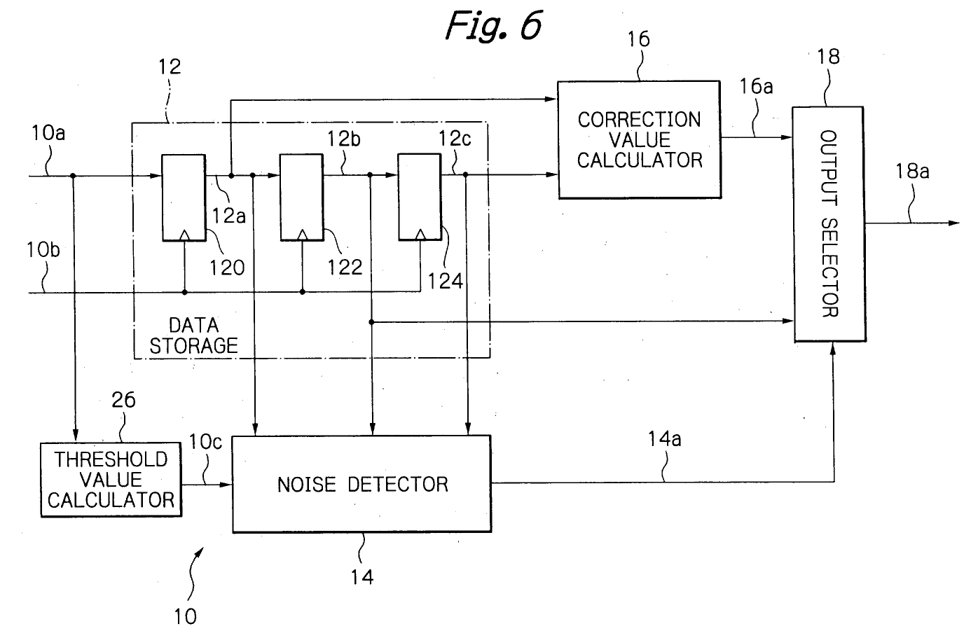

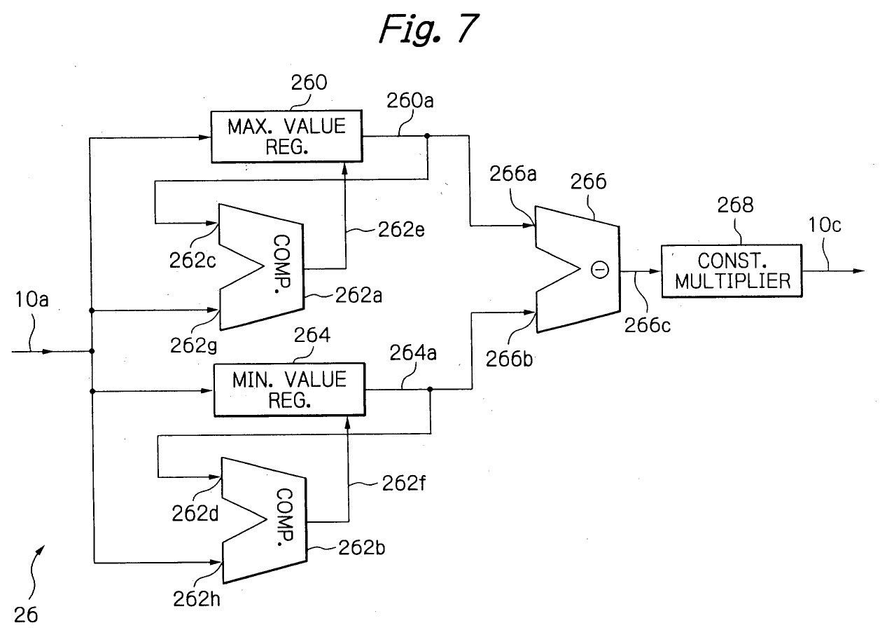

Referring to FIG. 6, the noise reduction circuit 10 has a threshold value calculator 26 interconnected as depicted in addition to the components of the previously described embodiment. The threshold value calculator 26 has the function of generating a threshold value based on the supplied input data 10a. Referring to FIG. 7, the threshold value calculator 26 includes a maximum value register 260, comparators 262a and 262b , a minimum value register 264, a subtracter 266, and a constant multiplier 268 interconnected as shown.

The maximum value register 260 and the minimum value register 264 serve as storing the maximum and minimum values from among the input data supplied during the preset time period, respectively. The maximum value register 260 outputs a maximum value 260a to one input terminal 262c of the one comparator 262a and also to one input terminal 266a of the subtracter 266. The minimum value register 264 outputs the minimum value 264a at a preset timing to one input terminal 262d of the other comparator 262b and also to another input terminal 266b of the subtracter 266. The maximum value register 260 and the minimum value register 264 are supplied with write enable signals 262e and 262f from the comparators 262e and 262f, respectively.

The one comparator 262a has the function of comparing the input data 10a to the maximum value 260a to determine the new maximum value among the input data 10a. If the new maximum value has been found among the input data 10a supplied on the terminal 262g , the comparator 262a outputs the write enable signal 262e to the maximum value register 260. The other comparator 262b has the function of comparing the input data 10a to the minimum value 264a to determine the new minimum value among the input data 10a. When the new minimum value is detected in the input data 10a supplied on the terminal 262h, the comparator 262a outputs the write enable signal 262f to the minimum value register 264.

The subtracter 266 has the function of calculating the maximum level range of the input data 10a during a preset time period. This level range is obtained by calculating a difference value between the maximum value 260a and the minimum value 264a . The subtracter 266 outputs a value of the calculated level range 266c to the constant multiplier 268.

The constant multiplier 268 has a multiplier, not shown explicitly, which is adapted to be supplied with a preset constant in order to multiply it by the value 266c of the supplied level range. This constant is preset to a value lesser than unity. The constant multiplying unit 268 outputs the multiplied results in the form of the threshold value 10c.

In the above-described arrangement, the threshold calculation updates the values stored in the maximum value register 260 and the minimum value register 264, among the values of the input data 10a supplied during a given time period, depending on the results of comparison 262e and 262f of the comparators 262a and 262b . The maximum value 260a and the minimum value 264a , read out from the maximum value register 260 and the minimum value register 264, respectively, are then supplied to the subtracter 266 to calculate the value 266c of the level range, which then is multiplied with a constant to generate a threshold value 10c. Since the threshold value 10c is generated based on the variable input data 10a, it is determined more flexibly than in the previously described, first modification so as to cope with dynamic changes. Thus, this threshold value 10c may cause noise detection to be carried out more appropriately to enable optimum noise correction.

<Third Modification>

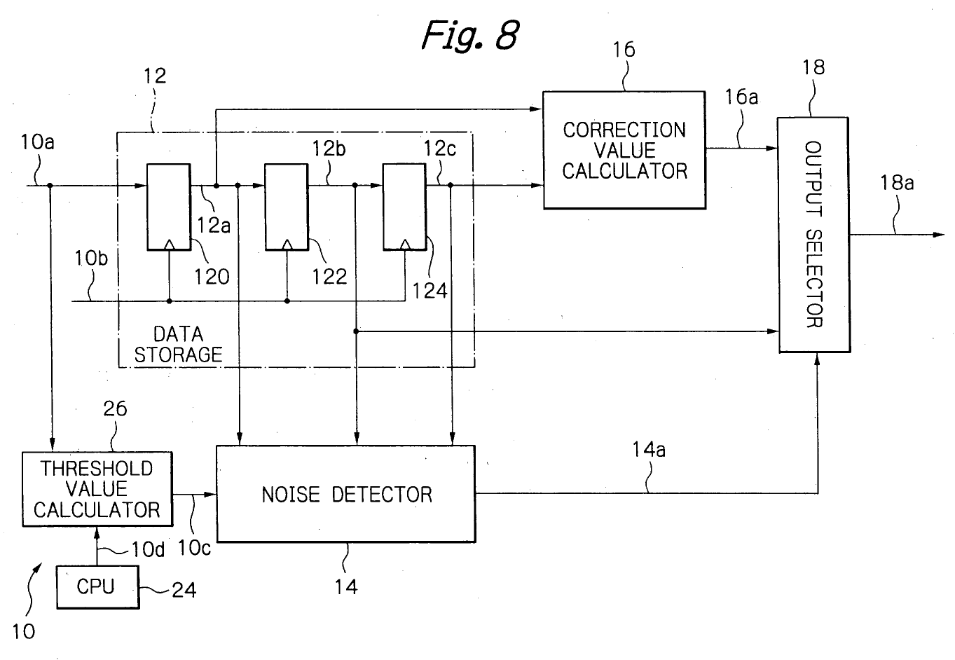

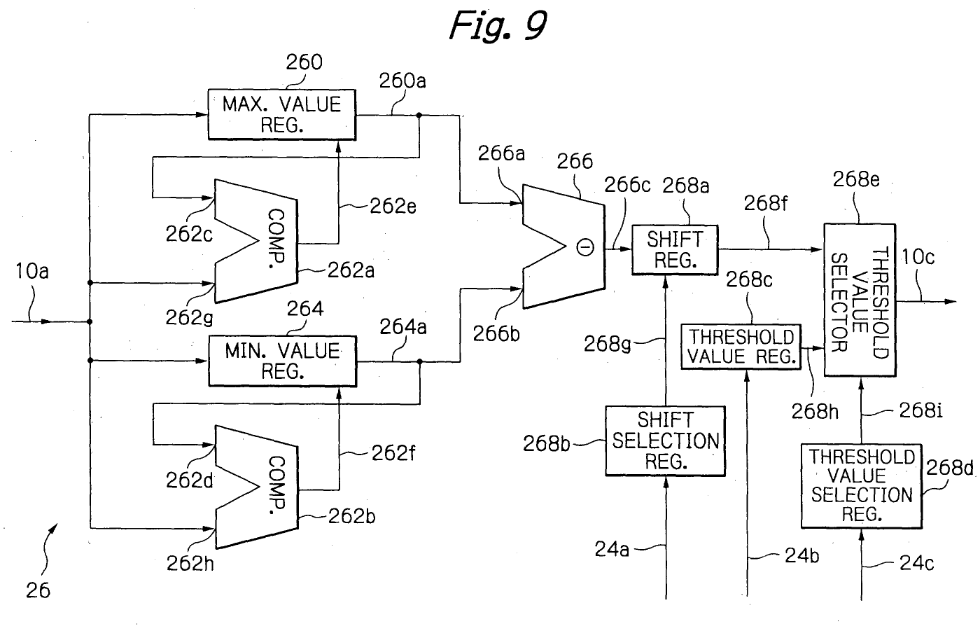

The noise reduction circuit 10 may be structured as a combination of the first and second modifications pertaining to the threshold value. More specifically, as shown in FIG. 8, the noise reduction circuit 10 includes a CPU 24 and a threshold value calculator 26 in addition to the configuration of the previously described embodiment. In particular, the threshold value calculator 26 includes a shift register 268a, instead of the constant multiplier 268 in the configuration shown in FIG. 7. Additionally, as shown in FIG. 9, the threshold value calculator 26 includes a threshold value register 268b, a shift selection register 268c, a threshold value selection register 268d and a threshold value selector 268e.

The threshold value register 268b, the shift selection register 268c and the threshold value selection register 268d serve as registers or memories for storing data to be supplied with control data 24a, 24b and 24c from the CPU 24, to store these data. The threshold value selector 268e is a two-input one-output selection circuit.

The shift selection register 268b holds supplied control data 24a and, responsive to the control data 24a, feeds the shift register 268a with a control signal 268g, representing the direction and amount of shift or the amount of right shift. Thus, the shift register 268a is under the shift control in response to a variable control signal 268g representing a multiplication coefficient, smaller than unity, to be multiplied with the value 266c of the supplied level range to accomplish its shift operation. The shift register 268a is responsive to the shift control to supply the threshold selector 268e with a threshold value 268f, shifted from the value 266c of the level range. The shift selection register 268b has the function of determining the bit shift amount corresponding to the value of the level range 266c.

The threshold value register 268c is supplied with a threshold value as control data 24b to provide the threshold value selector 268e with a threshold value 268h, read out at a preset timing, not shown (first threshold value). The threshold value selection register 268d holds the control data 24c to provide the threshold value selector 268e with a threshold value selection signal 268i at a preset timing to.

The threshold value selector 268e is responsive to a selection carried on the threshold value selection signal 268i to output either one of the supplied threshold values 268h and 268f (first and second threshold values), respectively. The threshold value selector 268e of the present embodiment outputs either one of the threshold values 268f and 268i as the threshold value 10c.

The threshold value calculator 26 generates a threshold value under the setting and selection control by the CPU 24. By enabling the threshold value 10c to be set from the CPU 24 as described above, adjustment may be made to accommodate to an error rate changeable with the radio communications conditions to assure more appropriate comprehensive noise reduction such as to cope with applications.

Although the foregoing embodiments have been described in terms of hardware, the invention is not to be restricted to the hardware but the same processing may be implemented by software as realized with the hardware. The noise reduction circuit 10 may, of course, be implemented by a combination of any of the above-described embodiments or modifications.

With the above arrangement, the bit information ascribable to noise is located among the bit error, a correction value is produced for the located bit from the bit information temporally before and after the detected bit, selection is made between noise correction and non-correction only on unusual one of the located bits, and the correction value is substituted for this unusual bit. It is therefore possible to prevent the data quality, and in particular the sound quality, from being degraded without suppressing the input signal in its entirety as in the case of filtering.

The noise detected can accommodate adaptively by memorizing the threshold value from the CPU 24 as noise detection proceeds. Since the threshold value is generated by calculations based on the input data, noise detection may be made in keeping with the input data, thus enabling more appropriate correction.

By selecting the threshold setting from the combination of the above-described two sorts of the threshold setting, it is possible to grasp the conditions of radio communications to set the threshold value in meeting with the state of communications to cope more flexibly with e.g., changes in the error rate. Thus, comprehensive noise correction may be achieved appropriately.

The noise reduction circuit 10 can be implemented not only by hardware but also by software programming to accomplish the functions of the constituent elements of the aforementioned embodiments. In other words, by utilizing the constituent elements of software processing as run in a signal processor system, the noise reducing function may be improved without providing new hardware elements, thus contributing to reduction in size of the entire device.

The entire disclosure of Japanese patent application No. 2002-288182 filed on Oct. 1, 2002, including the specification, claims, accompanying drawings and abstract of the disclosure is incorporated herein by reference in its entirety.

While the present invention has been described with reference to the particular illustrative embodiments, it is not to be restricted by the embodiments. It is to be appreciated that those skilled in the art can change or modify the embodiments without departing from the scope and spirit of the present invention.

What is claimed is:

1. A noise reduction apparatus comprising:
a data storage having a plurality of storage stages for holding input data with a chronological relationship of the input data maintained;
an output controller for detecting a magnitude of noise using data held by and output from said data storage, and for comparing the detected magnitude of the noise to a threshold value to produce a selection signal selecting data to be output;
a correction value calculator for using the held data to calculate correction data for the data to be output; and
an output selector operative in response to the selection signal for selecting either one of the data to be output and the correction data from among the held data.

2. The apparatus in accordance with claim 1, wherein said data storage comprises three registers for holding at least three successive samples of the input data.

3. The apparatus in accordance with claim 2, wherein the threshold value is a predetermined, fixed value.

4. The apparatus in accordance with claim 1, wherein said output controller comprises:
a first subtracter for calculating a first differential value between current data and past data among the held data, the current data indicating the data to be output, the past data indicating data directly previous to the current data;
a second subtracter for calculating a first differential value between the current data and the future data, the future data indicating data among the input data directly following the current data;
a first comparator for comparing an absolute value of the first differential value obtained on absolute value processing on the first differential value to the threshold value;
a second comparator for comparing an absolute value of the second differential value obtained on absolute value processing on the second differential value to the threshold value;
a decision circuit for verifying whether or not the first differential value is of an opposite sign to the second absolute value;
a comprehensive decision circuit operative in response to results of decision by said first and second comparators and said decision circuit for generating the selection signal; and
a threshold value output circuit for outputting the threshold value at a preset timing;
said apparatus further comprising a controlling circuit for controlling said threshold value output circuit as to setting the threshold value and as to outputting at the preset timing.

5. The apparatus in accordance with claim 1, wherein said correction value calculator comprises:
an adder for summing past data and future data among the held data, the past data indicating data directly previous to current data indicating the data to be output, the future data indicating data directly posterior to the current data; and
an average value calculator for calculating an average value from an output of said adder.

6. The apparatus in accordance with claim 3, wherein said correction value calculator comprises:
an adder for summing past data and future data among the held data, the past data indicating data directly previous to current data indicating the data to be output, the future data indicating data directly posterior to the current data; and
an average value calculator for calculating an average value from an output of said adder.

7. The apparatus in accordance with claim 4, wherein said correction value calculator comprises:
an adder for summing past data and future data among the held data, the past data indicating data directly previous to current data indicating the data to be output, the future data indicating data directly posterior to the current data; and
an average value calculator for calculating an average value from an output of said adder.

8. The apparatus in accordance with to claim 6, wherein said threshold value outputting circuit comprises:
a maximum value register for storing a maximum value of the input data;
a minimum value register for storing a minimum value of the input data;
a maximum value detector for comparing the input data to the maximum value;
a minimum value detector for comparing the input data to the minimum value;
a data range calculator for taking a differential value between the maximum and minimum values to output an absolute value of the differential value; and
a multiplier for multiplying the absolute value with a coefficient to output a result from multiplication as the threshold value.

9. The apparatus in accordance with claim 7, wherein said threshold value outputting circuit comprises:
a maximum value register for storing a maximum value of the input data;
a minimum value register for storing a minimum value of the input data;
a maximum value detector for comparing the input data to the maximum value;
a minimum value detector for comparing the input data to the minimum value;
a data range calculator for taking a differential value between the maximum and minimum values to output an absolute value of the differential value; and
a multiplier for multiplying the absolute value with a coefficient to output a result from multiplication as the threshold value.

10. The apparatus in accordance with claim 8, wherein said threshold value outputting circuit comprises:
a coefficient setting circuit for setting the coefficient for said multiplier;
a threshold value register for storing a supplied value as a first threshold value;
a threshold value selector for setting an output of said multiplier as a second threshold value and for selecting either one of the first and second threshold values; and
a selection command register for supplying a threshold value selection signal for commanding said threshold value selector to output a selection;
said controller controlling said coefficient setting circuit, said threshold value register and said selection command register.

11. The apparatus in according with claim 9, wherein said threshold value outputting circuit comprises:
a coefficient setting circuit for setting the coefficient for said multiplier;
a threshold value register for storing a supplied value as a first threshold value;
a threshold value selector for setting an output of said multiplier as a second threshold value and for selecting either one of the first and second threshold values; and
a selection command register for supplying a threshold value selecting signal for commanding said threshold value selector to output a selection;
said controller controlling said coefficient setting circuit, said threshold value register and said selection command register.

12. The apparatus in accordance with claim 10, wherein said multiplier comprises a shift register.

13. The apparatus in accordance with claim 11, wherein said multiplier comprises a shift register.

14. The apparatus in accordance with claim 1, further comprising a program sequence for implementing functions of said data storage, said output controller, said correction value calculator and said output selector.

15. The apparatus in accordance with claim 6, further comprising a program sequence for implementing functions of said data storage, said output controller, said correction value calculator and said output selector.

16. The apparatus in accordance with claim 7, further comprising a program sequence for implementing functions of said data storage, said output controller, said correction value calculator and said output selector.

17. The apparatus in accordance with claim 14, further comprising a program sequence for implementing function of said threshold value outputting circuit.

18. The apparatus in accordance with claim 15, further comprising a program sequence for implementing function of said threshold value outputting circuit.

19. The apparatus in accordance with claim 16, further comprising a program sequence for implementing function of said threshold value outputting circuit.
